(19) United States
(12) Patent Application Publication
(10) Pub. No.: US 2026/0268315 A1
(43) Pub. Date: Sep. 10, 2026

(54) MONITORING AND AUDITING TOOL OF BLOCKCHAIN BASED FINANCIAL PAYMENT AND CLEARING

(71) Applicant: REMI INVESTMENT LIMITED, NORTH POINT (HK)

(72) Inventor: Dong ZHU, Central (HK)

(21) Appl. No.: 19/224,641

(22) Filed: May 30, 2025

(30) Foreign Application Priority Data
Mar. 10, 2025 (HK) 22025104525.2

(51) Int. Cl. G06Q 20/38; G06Q 20/40

(52) U.S. Cl. CPC G06Q 20/38215; G06Q 20/401; G06Q 2220/00

(57) ABSTRACT

A monitoring and auditing tool of blockchain based financial payment and clearing, comprising a verification center for managing, verifying and querying transactions, a certificate authorization module; the verification center is provided and serves as a centralized center to monitor and audit the blockchain based financial payment and clearing for bridging the regulatory gap in blockchain decentralized system; the Verification Center serves as an international compliance data center, sharing risk intelligence with regulatory institutes worldwide.

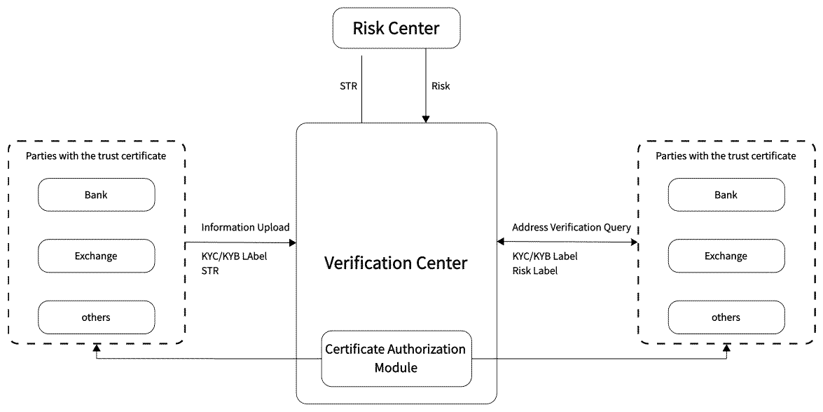

### FIELD OF THE INVENTION

The present invention involves a monitoring and auditing tool for blockchain based financial payment and clearing.

### BACKGROUND OF THE INVENTION

The Society for Worldwide Interbank Financial Telecommunication (SWIFT) has been the backbone of global cross-border transactions since 1973. It operates as a messaging network, enabling financial institutions to securely transmit payment orders. However, SWIFT does not handle fund transfers directly; instead, it relies on a network of correspondent banks to settle transactions. This process introduces multiple intermediaries, leading to delays (often 1-5 days), higher costs (due to fees from each intermediary and forex conversions), and opacity in transaction tracking. While SWIFT's standardized messaging (MT/MX formats) ensures interoperability, its centralized architecture and legacy infrastructure struggle with inefficiencies in today's demand for real-time, low-cost transactions.

Blockchain technology, a decentralized ledger system, offers transformative potential for clearing and settlement by addressing SWIFT's limitations, and have following characteristics:

### Decentralization:

Transactions do not rely on traditional financial institutions (e.g., banks) but are validated by a distributed network of nodes, eliminating centralized oversight.

Transparency vs. Anonymity Paradox:

Transaction records are publicly accessible (e.g., Bitcoin blockchain), but addresses are not directly linked to real-world identities, creating “pseudonymity.”

### Immutability:

Data on the blockchain cannot be altered once recorded. However, this also makes reversing illicit transactions (e.g., money laundering) technically impossible.

But applying blockchain technology in the field of virtual currency will cause following challenges:
1. Anonymity Abuse and Money Laundering Risks
2. Cross-Border Transactions and Regulatory Arbitrage

### Global Instant Settlement:

Virtual currencies can be transferred across jurisdictions instantly (e.g., via cross-chain bridges), evading localized regulations.

### Regulatory Fragmentation:

Inconsistent definitions of virtual currencies (e.g., property in the U.S. vs. financial instruments in the EU) hinder international coordination.
3. DeFi Compliance Dilemmas

### Lack of Accountability:

Decentralized protocols lack centralized entities to enforce AML obligations, such as the FATF's “Travel Rule.”

### Flash Loan Exploits:

Attacks exploiting smart contract vulnerabilities (e.g., the $182 million Beanstalk hack in 2022) highlight risks in automated systems.

So, the core technical features of virtual currencies: decentralization, cryptographic privacy, and smart contracts, are both drivers of innovation and sources of regulatory complexity. But it is necessary to take effective regulation requirements to address the “Decentralized” regulatory gap, balance privacy and transparency and mitigate smart contract risks.

### SUMMARY OF THE INVENTION

In view of the aforesaid drawbacks of the prior art, the present invention provides a monitoring and auditing tool of blockchain based financial payment and clearing as following solutions.

A monitoring and auditing tool of blockchain based financial payment and clearing, comprising:
a verification center for managing, verifying and querying transactions handled by blockchain based clearing and settlement service system for financial payment and clearing;
a certificate authorization module for releasing and verifying trust certificates of parties who deploy or use the blockchain based clearing and settlement service system;
at least a transaction information of a transaction purpose is embedded into a specific stablecoin for transferring the fiat currencies value and risk control information;
transaction information of KYC/KYB and proof of the transaction purpose are collected and kept by the initiate party and the receive party which are certified by the certificate authorization module;
the verification center monitors all the transactions dealing by the blockchain based clearing and settlement service system; when a STR raised, the verification center requests the initiate party and receive party to provide the KYC/KYB and the proof of the transaction purpose, verifies the risk of the transaction, and keep the record of the risk.

Further, an agency of the trust certificate issuing is a financial institution, a web3 wallet provider and third party trusted by the certificate authorization module.

Further, a risk center is provided and communicated with the verification center; the risk center takes over the STR handling procedure and feedback the risk record to the verification center.

Further, the initiate party and receive party can raise a query to the verification center to get the risk record to evaluate the risk of subsequent transactions.

Further, each party with the trust certificate is assigned appropriate permissions for accessing the information of transaction and risk record.

Further, the parties with the trust certificate are divided into
group 1: financial institutions and web3 wallet providers, who are the users of the blockchain based clearing and settlement service system, and have the permission to review the record of transaction that is initiated;
group 2: regulatory agencies, who have permission to review the transaction and risk record of the transaction.

Further, the parties with the trust certificate are also include:
group 3: observers, who monitor the operation of the blockchain based clearing and settlement service system and the verification center, have permission to review all the record of transaction and the risk record and propose regulatory recommendations.

Further, the transaction information also includes the fields of whether the initiate party and the receive party collect the KYC/KYB.

Further, the STR includes the fields of: report institution, client information of the transaction, transaction information, description of suspicious transaction report and crime report.

The present invention has the following advantages: the verification center is provided and serves as a centralized center to monitor and audit the blockchain based financial payment and clearing for bridging the regulatory gap in blockchain decentralized system. The transaction information deployed to the blockchain ledge is similar to normal virtual currency, such as transaction hash, initiate party address, receive party address, transaction amount, digital signature, etc. And the transaction purpose is additional transaction information being added into the blockchain ledge for meeting the regulatory requirement. So, the private information, such as KYC/KYB and proof of the transaction purpose, will not be disclosed in the blockchain ledge to maintain the anonymity character of blockchain. And each party who involves in the blockchain based clearing and settlement service system for financial payment and clearing, must be trust verified with trust certificate to handling the transaction, deploying the transaction information such as initiate party address, receive party address and digital signature for the verification center can trace every transaction on the blockchain. The trust parties must keep KYC/KYB and proof of the transaction purpose inside the institute for regulatory monitoring and auditing. Once a STR (suspicious transaction report) raised or under the request of regulatory agencies, the initiate party address and receive party must transmit the KYC/KYB and proof of the transaction purpose to the verification center to verify the risk of the transaction and keep the record of the risk. The Verification Center serves as an international compliance data center, sharing risk intelligence (e.g., suspicious transaction patterns) with regulatory institutes worldwide.

### BRIEF DESCRIPTION OF THE DRAWINGS

Below are explanations of the invention combining with drawings.

The sole FIGURE is the system architecture diagram of the present invention.

### DESCRIPTION OF THE EMBODIMENTS

Referring to the sole FIGURE, a monitoring and auditing tool of blockchain based financial payment and clearing, comprising;
a verification center for managing, verifying and querying transactions handled by blockchain based clearing and settlement service system for financial payment and clearing;
a certificate authorization module for releasing and verifying trust certificates of parties who deploy or use the blockchain based clearing and settlement service system;
at least a transaction information of a transaction purpose is embedded into a specific stablecoin for transferring the fiat currencies value and risk control information;
transaction information of KYC/KYB and proof of the transaction purpose are collected and kept by the initiate party and the receive party which are certified by the certificate authorization module;
the verification center monitors all the transactions dealing by the blockchain based clearing and settlement service system; when a STR raised, the verification center requests the initiate party and receive party to provide the KYC/KYB and the proof of the transaction purpose, verifies the risk of the transaction, and keep the record of the risk.

The verification center is provided and serves as a centralized center to monitor and audit the blockchain based financial payment and clearing for bridging the regulatory gap in blockchain decentralized system. The transaction information deployed to the blockchain ledge is similar to normal virtual currency, such as transaction hash, initiate party address, receive party address, transaction amount, digital signature, etc. And the transaction purpose is additional transaction information being added into the blockchain ledge for meeting the regulatory requirement. So, the private information, such as KYC/KYB and proof of the transaction purpose, will not be disclosed in the blockchain ledge to maintain the anonymity character of blockchain. And each party who involves in the blockchain based clearing and settlement service system for financial payment and clearing, must be trust verified with trust certificate to handling the transaction, deploying the transaction information such as initiate party address, receive party address and digital signature for the verification center can trace every transaction on the blockchain. The trust parties must keep KYC/KYB and proof of the transaction purpose inside the institute for regulatory monitoring and auditing. Once a STR (suspicious transaction report) raised or under the request of regulatory agencies, the initiate party address and receive party must transmit the KYC/KYB and proof of the transaction purpose to the verification center to verify the risk of the transaction and keep the record of the risk. The Verification Center serves as an international compliance data center, sharing risk intelligence (e.g., suspicious transaction patterns) with regulatory institutes worldwide.

For monitoring and auditing every truncation by the blockchain based clearing and settlement service system, the transaction can only be initiated and received by trust parties for risk control. To verify the trust parties, the certificate authorization module will manage all the certificates used by the trust parties. It can issue certificates to trust parties or may manage the certificates issued by trust parties. Such trust parties must be credible institutions, such as Financial Institution (Banks, Securities companies, Insurance companies, Investment companies, Trust companies, etc.), web3 wallet providers (Cryptocurrency Exchanges), Financial regulatory agencies, etc.

A risk center is provided. It serves as risk control monitoring and auditing all the transactions in the blockchain. It communicates with the verification center to take over the STR handling procedure and feedback the risk record to the verification center for controlling the risk transaction.

According to the anti-money laundering laws and regulations of some counties, the exchange and transfer of digital assets are subject to anti-money laundering laws. The following provisions are made:
KYC requirements for both parties in on-chain transactions
Requirements for on-chain transactions on the fields that need to be recorded for a certain transfer
Suspicious transaction reporting requirements for on-chain transactions

Therefore, the fields and information that should be collected are as follows:

KYC Form

| | | Report to | |
|---|---|---|---|
| | | verification | |
| SN | Filed | center | Compulsive? |
| 1 | First Name if collected | YES OR NO | YES |
| 2 | Middle Name if | YES OR NO | YES |
| | collected | | |
| 3 | Last Name if collected | YES OR NO | YES |
| 4 | Date of birth if | YES OR NO | YES |
| | collected | | |
| 5 | Gender if collected | YES OR NO | YES |
| 6 | Nationality if collected | YES OR NO | YES |
| 7 | ID type | ID, driving | YES |
| | | license, voter | |
| | | card, passport, | |
| | | others | |
| 8 | ID number if collected | YES OR NO | YES |
| 9 | ID Document Expiry | YES OR NO | YES |
| | Date | | |
| 10 | Address if collected | YES OR NO | YES |
| 11 | Contact number if | YES OR NO | YES |
| | collected | | |
| 12 | Contact e-mail if | YES OR NO | YES |
| | collected | | |
| 13 | Face liveness if passed | YES OR NO | YES |
| 14 | official database | YES OR NO | YES |
| | verification | | |
| 15 | Date of verification | DATE or not | YES |
| | | applicable | |
| 16 | POA if collected | YES OR NO | YES |

KYB Forms

| | | | Report to | |
|---|---|---|---|---|
| | | | verification | |
| SN | Filed | Detail | center | Compulsive? |
| 1 | Legal Name of | | YES OR NO | YES |
| | corporation if | | | |
| | collected | | | |
| 2 | Certificate of | | YES OR NO | YES |
| | incorporation | | | |
| | number if collected | | | |
| 3 | Business category if | Non-finiancial | Type or not | YES |
| | collected | Corporate | applicable | |
| | | Bank | | |
| | | Crypto Exchange | | |
| | | Other financial | | |
| | | institution | | |
| 4 | Contact number if | | YES OR NO | YES |
| | collected | | | |
| 5 | Contact e-mail if | | YES OR NO | YES |
| | collected | | | |
| 6 | Establishment Date | | YES OR NO | YES |
| | and Registration | | | |
| | Expiry Date if | | | |
| | collected | | | |
| 7 | Registered office | | YES OR NO | YES |
| | address if collected | | | |
| 8 | Business | | YES OR NO | YES |
| | License/Business | | | |
| | Registration | | | |
| | Certificate if | | | |
| | collected | | | |
| 9 | Lease Contract if | | YES OR NO | NO |
| | collected | | | |
| 10 | Tax Registration | | YES OR NO | NO |
| | Certificate if | | | |
| | collected | | | |
| 11 | Latest Annual | | YES OR NO | NO |
| | Return (if | | | |
| | applicable) if | | | |
| | collected | | | |

| | | | |
|---|---|---|---|
| | | Report to | |
| | | verification | |
| SN | Filed | center | Compulsive? |

Directors Information

| | | | |
|---|---|---|---|
| 1 | Directors List if | YES OR NO | YES |
| | collected | | |
| 2 | Directors Identity | YES OR NO | NO |
| | Document if collected | | |
| 3 | Directors Proof of | YES OR NO | NO |
| | Address if collected | | |

Ultimate Beneficial Owner Information

| | | | |
|---|---|---|---|
| 1 | List of UBOs | YES OR NO | YES |
| | (shareholders/ | | |
| | beneficiaries with a | | |
| | shareholding ratio | | |
| | greater than 25%) if | | |
| | collected | | |
| 2 | UBO Identity | YES OR NO | No |
| | Document if | | |
| | collected | | |
| 3 | UBO Proof of | YES OR NO | NO |
| | Address if collected | | |
| 4 | UBO Control | YES OR NO | NO |
| | Statement if | | |
| | collected | | |

Shareholders & Ownership Structure

| | | | |
|---|---|---|---|
| 1 | Shareholders List if | YES OR NO | YES |
| | collected | | |
| 2 | Shareholding | YES OR NO | NO |
| | Structure Diagram if | | |
| | collected | | |
| 3 | Share Certificates if | YES OR NO | NO |
| | collected | | |

| | | | | |
|---|---|---|---|---|
| | | | Report to | |
| | | Compliance | verification | |
| SN | Filed | Assessment | center | Compulsive? |

Bank Account Information

| | | | | |
|---|---|---|---|---|
| 1 | Company Bank | Bank Name, Account | YES OR NO | NO |
| | Account Details if | Number, SWIFT/BIC | | |
| | collected | Code. | | |
| 2 | Latest 3-6 Months | to prove the transaction | YES OR NO | NO |
| | Bank Statements if | status and fund flow of | | |
| | collected | the company's account. | | |

Business Verification Documents

| | | | | |
|---|---|---|---|---|
| 1 | Business Contracts/ | Recent business | YES OR NO | NO |
| | Invoices if collected | contracts or invoices | | |
| | | to prove that the | | |
| | | company has real | | |
| | | business operations. | | |
| 2 | List of Major Suppliers/ | Proof of the | YES OR NO | NO |
| | Customers if collected | authenticity of the | | |
| | | company's business | | |
| | | operations (if | | |
| | | applicable). | | |
| 3 | Company Website/Online | Company website | YES OR NO | NO |
| | Business Proof if collected | URL, or other online | | |
| | | business proof. | | |

Other Supporting Documents

| | | | | |
|---|---|---|---|---|
| 1 | Licenses/Permits (if | Certain industries | YES OR NO | YES |
| | applicable) if collected | require relevant | | |
| | | business licenses. | | |
| 2 | AML & Compliance Policy | Certain industries | YES OR NO | NO |
| | if collected | require relevant | | |
| | | business licenses. | | |
| 3 | Latest Financial Statements | Most recent balance | YES OR NO | NO |
| | if collected | sheet, income | | |
| | | statement (if | | |
| | | applicable). | | |

Fields for initiating a transfer (AML Travel Rule)

| | | | Report to | |
|---|---|---|---|---|
| | | | verification | |
| SN | Field | Detail | center | Compulsive? |
| Transaction | Initiator | | name or not | NO |
| Initiator | name | | applicable | |
| Information | Initiator | | Residential address or | NO |
| | address | | not applicable | |
| | Initiator ID | | ID number or not | NO |
| | number | | applicable | |
| | Initiator Date | | Date or not applicable | NO |
| | of birth | | | |
| Transaction | Receiver | | name or not | NO |
| Receiver | name | | applicable | |
| Information | | | | |
| Transaction | Transaction | Individual to Individual | | YES |
| Details | type | Fund Position Transfer | | |
| | | among banks and | | |
| | | financial institutions | | |
| | | FX settlement | | |
| | | Payment in commercial | | |
| | | purpose | | |
| | | Crypto Exchange | | |
| | | investment | | |
| | | Others | | |
| | Evidence | | | NO |

STR FORM

| Category | Field | Compulsive? |
|---|---|---|
| Basic information of | Institution | YES |
| the report | Institution Code | NO |
| | Date of Report | YES |
| Customer basic | Name | YES |
| information | Type | YES |
| | Certification Type | YES |
| | Certification Number | YES |
| | Date of Birth | YES |
| | Nationality | YES |
| | Contact Number | YES |
| | Email | YES |
| | Address | YES |
| | Registration Time | YES |
| Related transaction | Transaction Time | YES |
| details | Transaction Type | YES |
| | Amount | YES |
| | Currency Type | YES |
| | Account No/Wallet Address | YES |
| | Counterparty's Account No/ | YES |
| | Wallet Address | |
| | Counterparty's Name | YES |
| | Counterparty's Institution | YES |
| Description of | Category of Suspicion | YES |
| suspicious activity | Crime Type | YES |
| | Risk Level | YES |
| | Control Measures | YES |

1. A monitoring and auditing tool of blockchain based financial payment and clearing, comprising:
a verification center configured to manage, verify, and query transactions processed by a blockchain based clearing and settlement service system;
a certificate authorization module configured to issue and verify trust certificates for parties that deploy or use the blockchain-based clearing and settlement service system;
wherein the verification center is further configured to:
monitor all transactions processed by the blockchain-based clearing and settlement service system,
receive a suspicious transaction report (STR) triggered based on predefined risk criteria,
in response to the STR, request an initiating party and a receiving party to provide Know-Your-Customer (KYC) or Know-Your-Business (KYB) information and a proof of transaction purpose,
verify a risk level of the transaction based on the provided KYC/KYB information and the proof of transaction purpose, and
store a record of the verified risk level;
wherein at least transaction purpose information is embedded into a stablecoin to enable transfer of fiat currency value, while the KYC/KYB information and the proof of transaction purpose are maintained off-chain by the initiating party and the receiving party.

2. The monitoring and auditing tool of claim 1, wherein an agency that issues the trust certificate is a financial institution, a web3 wallet provider, or a third party trusted by the certificate authorization module.

3. The monitoring and auditing tool of claim 1, further comprising a risk center configured to communicate with the verification center, wherein the risk center is configured to take over the STR handling procedure and to feedback a risk record to the verification center.

4. The monitoring and auditing tool of claim 1, wherein the initiating party and the receiving party are configured to raise a query to the verification center to obtain the risk record for evaluating a risk of a subsequent transaction.

5. The monitoring and auditing tool of claim 1, wherein each party holding the trust certificate is assigned appropriate permissions for accessing transaction information and the risk record.

6. The monitoring and auditing tool of claim 5, wherein the parties holding the trust certificate are divided into:
group 1: financial institutions and web3 wallet providers, which are users of the blockchain-based clearing and settlement service system and have permission to review a record of a transaction that they initiated; and
group 2: regulatory agencies, which have permission to review the transaction and the risk record of the transaction.

7. The monitoring and auditing tool of claim 6, wherein the parties holding the trust certificate further include:
group 3: observers configured to monitor operation of the blockchain-based clearing and settlement service system and the verification center, wherein the observers have permission to review all transaction records and risk records and to propose regulatory recommendations.

8. The monitoring and auditing tool of claim 6, wherein the transaction information further includes a field indicating whether the initiating party and the receiving party have collected the KYC/KYB information.

9. (canceled)
